(19) United States
(12) Patent Application Publication
(10) Pub. No.: US 2015/0070880 A1
(43) Pub. Date: Mar. 12, 2015

(54) BAG EQUIPPED WITH A LIGHTING AND POWER SYSTEM

(71) Applicants: Sara Giunti, Roma (IT); Antonio Cantagallo, Roma (IT)

(72) Inventors: Sara Giunti, Roma (IT); Antonio Cantagallo, Roma (IT)

(73) Assignee: Sara GIUNTI, Roma (IT)

(21) Appl. No.: 14/385,419

(22) PCT Filed: Jan. 22, 2013
(86) PCT No.: PCT/IB2013/050552

§ 371 Date: Sep. 15, 2014

(30) Foreign Application Priority Data
Mar. 14, 2012 (IT) MI2012U000100

(51) Int. Cl. A45C 15/06; F21V 23/04

(52) U.S. Cl. CPC A45C 15/06; F21V 23/04; F21Y 2103/003
USPC 362/155

(57) ABSTRACT

A handbag includes a casing (2) defining a compartment (3) with an opening (7) produced in the upper part and provided with closing elements (8), illumination devices (9) placed inside the compartment (3) close to the opening (7), a battery (10) adapted to supply the illumination devices (9), a switch (11) operably connected to the closing elements (8) of the compartment (3), a connection device (14) configured to connect to an external charging device, a control unit (20) configured to control at least the illumination devices (9) and the connection device (14), at least the battery (10), the connection device (14) and the control unit (20) being placed on the bottom (4) of the handbag.

The present invention relates to a handbag provided with an illumination and power supply system. In particular, the invention relates to a handbag provided with means adapted to illuminate its inside to facilitate the search for items contained therein. The handbag according to the invention is also provided with an electrical supply device to charge battery operated electronic devices.

A common problem in the use of ladies' bags or handbags is that of distinguishing a specific item to be removed from the handbag from others contained therein. This is particularly tiresome in conditions of poor light, as it is necessary to identify an item only by its shape, especially when there are items of similar shape inside the handbag (such as two different sets of keys).

To overcome these drawbacks, handbags, purses or the like have been produced provided with illumination devices adapted to illuminate the inner compartment of the handbag, supplied by batteries or the like, and which can be activated through switches connected to the closure of the handbag.

An example of handbag with this configuration is described in the German patent application DE10338905.

Another example of a handbag provided with means adapted to illuminate the items inserted therein is described in the United Kingdom patent application GB2082898.

These prior art objects are nonetheless subject to further improvement.

In fact, bags with this configuration are generally more complicated to produce than a conventional handbag, due to the presence of various electrical or electronic components that must be inserted therein.

In particular, these components must be integrated in the body of the handbag so that they do not alter either its normal usability and functionality, or its physical appearance, very important in this type of product.

However, at the same time the components must be designed and arranged so that they are easily accessible to facilitate any maintenance operations in the event of faults.

The present invention relates to this field, proposing a handbag provided with an improved illumination and power supply system to make up for the shortcomings of prior art devices.

In particular, an object of the invention is to propose a handbag provided with an illumination and power supply system that enables easy installation of the various components therein and therefore simple and quick maintenance in the event of a fault in one of the components.

Another object of the invention is to propose a handbag provided with an illumination and power supply system that offers the user maximum practicality of use, comparable to that of a conventional handbag.

In detail, an object of the present invention is to propose a handbag provided with an illumination and power supply system supplied by a battery that can be charged easily without the use of cables.

A further object of the present invention is to propose a handbag provided with an illumination and power supply system, which enables the capacity of the battery to be used to charge electronic devices contained therein.

The above objects are substantially achieved by a handbag according to one or more of the appended claims.

In particular, these objects are achieved by a handbag comprising a casing defining a compartment with an opening produced in the upper part and provided with closing means, illumination devices placed inside said compartment close to said opening, a battery adapted to supply said illumination devices, a switch operably connected to said closing means of the compartment, a connection device configured to connect to an external charging device, a control unit configured to control at least said illumination devices and said connection means, at least said battery, said connection means and said control unit being placed on the bottom of the handbag.

Further characteristics and advantages will be more apparent from the indicative, and therefore non-limiting, description of an example of a preferred but not exclusive embodiment of the invention, as shown in the accompanying figures wherein:

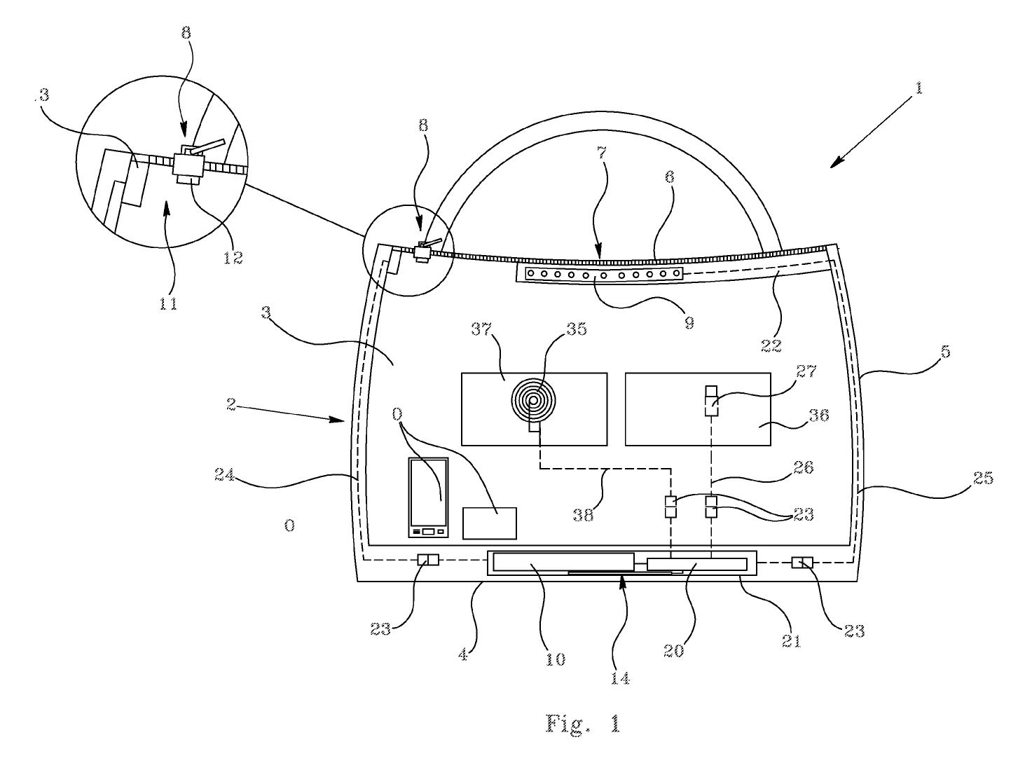

FIG. 1 is a sectional front view of a handbag according to the invention;

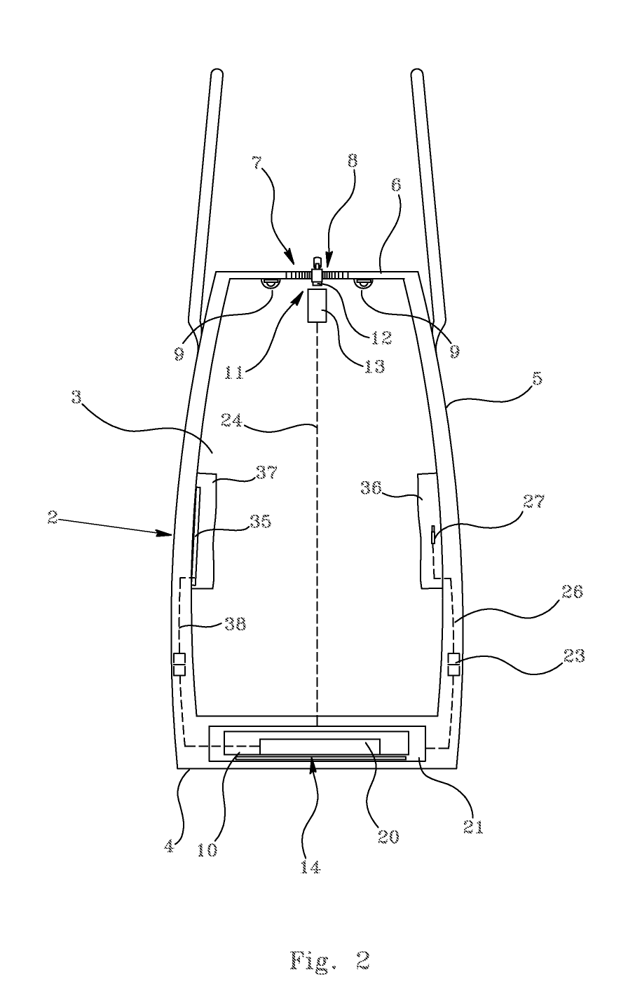

FIG. 2 is to sectional side view of the handbag of FIG. 1.

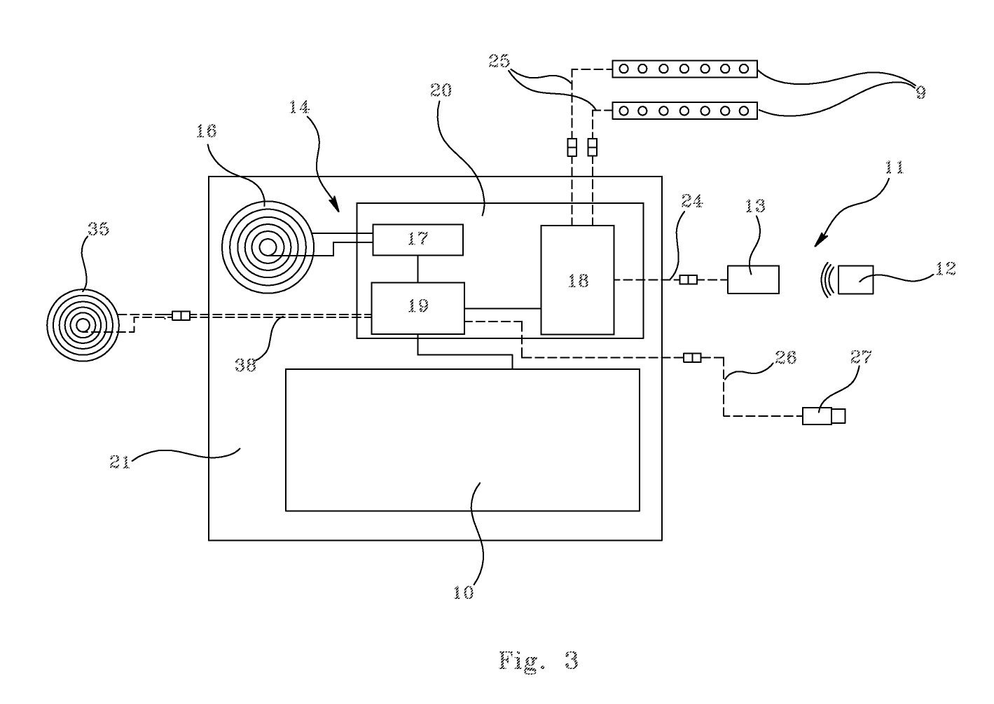

FIG. 3 is a schematic representation of the components of the illumination and power supply system according to the invention;

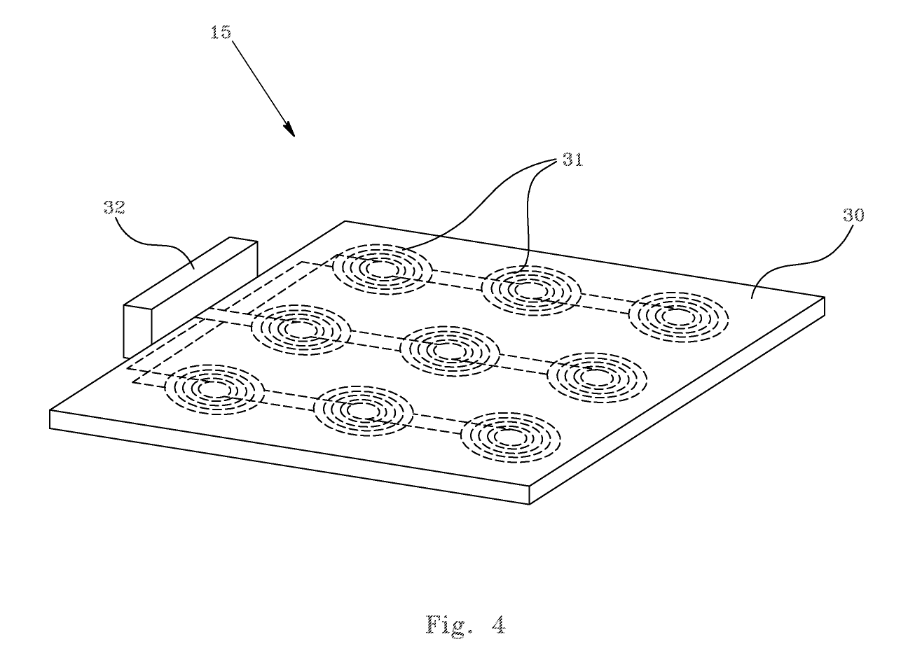

FIG. 4 is a perspective view of a charging device of the handbag according to the invention;

With reference to the accompanying figures, the handbag comprises a casing 2 defining an inner compartment 3 adapted to contain items O.

Said casing can be made of any material compatible with the use of a handbag, for example fabric, leather, hide, plastic materials and the like.

Said casing can comprise, for example, at least one bottom 4, one or more lateral walls 5 and an upper wall 6.

The external shape of the casing is not binding for the purposes of the invention; for example, said bottom 4 could be produced in one piece with the lateral wall or walls 5, just as said walls could be produced in one piece with the upper wall 6.

Preferably, in the upper part of said casing 2, and more specifically in the upper wall 6, an opening 7 is produced to enable access to the inner compartment 3 to remove or insert items O.

However, according to the shape of the casing, said opening can also be provided laterally or, in any other position on the casing 2.

The casing also comprises closing means 8 adapted to partially or completely close said opening 7. Said closing means can comprise a zip, buttons, clips or in general any type of known closure.

According to the invention, the handbag is provided with illumination devices 9 adapted to illuminate the inner compartment 3 and the items contained therein.

For this purpose said illumination devices are preferably located in the upper part of the casing and more specifically close to the opening 7.

According to a preferred embodiment, said illumination devices comprise a plurality of LEDs arranged along the perimeter of the opening 7.

More in detail, said illumination devices comprise at least one “LED strip”, i.e. a strip of flexible material provided with a plurality of LEDs, all supplied through a single external connection.

For example, in a handbag provided with zip closure, such as the one shown in the figure, it is possible to install a pair of “LED strips” inside the casing, each at one edge of the opening 7.

For example, said “LED strips” can be housed in specific tubular compartments 22 produced with a textile capable of allowing light to pass through (thin or perforated), or with a transparent plastic material.

The power supply for said illumination devices 9 is provided with a battery 10, preferably a rechargeable battery.

To ensure maximum practicality of use for the user, activation and deactivation of the illumination devices 9 is controlled by a switch 11 operably connected to the closing means 8 of the opening 7.

In detail, said switch enables the lighting device to be switched on automatically when the casing 2 is opened by means of the closing means 8, and vice versa switched off once the casing is closed.

According to the invention, said switch 11 comprises at least one magnet 12 and one reed contact 13.

Preferably, said magnet 12 is positioned on a moving portion of said closing means, while the reed contact 13 is in a fixed position on the casing of the handbag.

When the casing is closed the magnet 12 and the contact 13 are moved together so that the magnetic field of the magnet can energize the reed contact, maintaining the illumination devices switched off.

Instead, when the casing 2 is open, the magnet 12 is moved away from the reed contact 13, which deactivates to enable said illumination devices 9 to switch on.

Even more in detail, said reed contact 13 is connected to a switch control circuit 18, interposed between the battery 10 and the illumination devices 9, capable of perceiving the open or closed state of the reed contact and of enabling or preventing passage of the current towards said lighting devices (FIG. 3).

According to the invention, the handbag is also provided with a connection device, indicated as a whole with 14, which enables the battery 10 to be charged through an external charging device, indicated as a whole with 15.

Advantageously, said connection device 14 enables the battery 10 to be charged without the aid of cables or the like connected to the handbag (FIG. 3).

More specifically, said connection means 14 comprise at least one coil 16, configured to pick up a magnetic field emitted by the charging device 10 and transform it into an electric signal, and a transformer circuit 17, connected to said coil, capable of modulating said signal with a voltage and current value compatible with those of the battery 10.

The number and the dimension of the coils 16 can be varied according to the capacity of the battery to be charged, and to the specifications of the charging device 15.

Said transformer circuit 17, said switch control device 18 and said battery 10 are connected to a charge and supply control circuit 19 and managed by it.

In detail, said charge and supply control circuit 19 is configured to receive from the switch control device 18 a signal indicating opening or closing of the casing 2 and, according to this, to enable or prevent the passage of current from the battery 10 towards the illumination devices 9.

Said charge and supply control circuit 19 is also configured to receive from the transformer circuit 17 a modulated current and transfer it to the battery 10 to charge it. When the battery 10 is completely charged, said circuit 19 interrupts the supply and the charge.

When the handbag is connected to the charging device 15, the charge and supply control circuit 19 bypasses the battery 10 and in the event of opening of the casing 2, supplies the illumination devices 9 directly through the transformer circuit 17.

According to the invention, said transformer circuit 17, said switch control circuit 18 and said charge and supply control circuit 19 are comprised in a single control unit, indicated as a whole with 20.

Advantageously, said control unit 20, said battery 10 and said coil 16 are placed on the bottom 4 of the handbag in such a manner that they do not create any inconvenience to the user or reduce the capacity of the inner compartment 3.

According to a preferred embodiment, said battery 10, said control unit 20 and said coil 16 are produced in a single preassembled and sealed body 21.

Due to the configuration of the various components, said body can assume a thin flat shape which is well suited to arrangement on the bottom 4 of the casing.

For this purpose, the bottom 4 of the casing is provided with a pocket, closed by a zip or by a hook and loop closure, which enables easy and quick insertion or removal of the body 21 therein or therefrom.

Advantageously, said body is produced at least partly in a soft material, capable of absorbing impacts and protecting the various components, and preferably waterproof to prevent them from getting wet. Materials such as expanded polyethylene or the like are well suited for this use.

To facilitate maintenance operations, said body 21 is provided with quick release connections 23 on a connection cable 24 with the reed contact 13 and on the connection cables 25 with the illumination devices 9.

Said cables are preferably positioned under an inner lining of the casing, not visible in the figure, in such a manner as to be totally hidden from view.

In this way, in the event of a fault of one of the aforesaid components, it is sufficient to uncouple the connections and replace the component.

Likewise, in the event of a breakage of one of the components inside the body 21 (control unit 20, battery 10 or coils 16) it can be quickly and easily disconnected from the reed contact 13 and from the illumination devices 9, and replaced with a new one.

This solution enables the user to restore all the devices of the handbag to working order almost immediately, without having to leave the handbag at stores or with service centres to be repaired.

The replaced body 21 can subsequently be re-used, after the damaged component has been repaired or restored at service centres, in the same way as many other electronic devices.

Preferably, according to the invention the handbag is also provided with a power supply system to charge battery-operated electronic devices such as phones, smartphones, MP3 players, electronic planners or the like.

According to a preferred embodiment, said power supply system comprises a power supply cable 26, connected to the charge and supply circuit 19 of the control unit 20, provided at one end with a connector 27 for connection of an electronic device.

Said connector 27 can be of standard type (USB, mini-USB, micro-USB) or of proprietary type and dedicated to devices of a given manufacturer.

Advantageously, said power supply cable 26 is also provided with a quick release connection 23 to be uncoupled from the body 21.

Said power supply cable 26 can reach a housing 27, such as a pocket 36 or the like, in which the electronic device to be charged can be placed.

According to another embodiment, said power supply system can comprise a coil 35 connected to the charge and supply circuit 19 of the control unit 20 through a power supply cable 38, adapted to generate a magnetic field that can interact with an electronic device to charge it. Also in this case, the coil 35 can be placed in a pocket 37 of the bag; in this way it is sufficient to place the electronic device in the pocket to start charging.

According to the invention, the handbag can be provided in a kit comprising a charging device 15 illustrated in FIG. 4.

Said device comprises a support 30 with a substantially flat body provided with means 31 configured to generate a magnetic field adapted to interact with the connection device 14 of the handbag.

More in detail, said means comprise at least one coil, buried inside said support 30, supplied by a driving circuit 32 in turn connected to the electricity network through a transformer (not visible in the figure).

In this way when the charging device is active, it is sufficient to place the handbag on the support 31 for the magnetic field generated by the coil 31 to interact with the coil 16 of the connection device 14 of the handbag and enable charging of the battery 10.

This charging system, without the aid of cables or the like, ensures maximum practicality for the user and does not involve substantial variations in the habitual uses of a conventional handbag.

Preferably, the device comprises a plurality of coils 31 arranged on a matrix that extends substantially for the entire surface of the support.

This enables the handbag to be placed on the support 30 in a more or less random manner, however ensuring interaction between at least one emitting coil 31 of the charging device and the coil 16 of the handbag.

Said support 30 is preferably made of a light, strong and deformable material, such as rubber, cardboard or corrugated plastic.

Preferably, if the charging device 15 is provided in a kit, said support 30 can be covered with the same material as the casing of the bag or with a material decorated in a manner that matches its design elements.

Advantageously, inside the compartment 3, and preferably in an upper area of the casing, the handbag can be provided with a small panel (not shown in the figure), connected to the control, charge and supply unit 19, with some LEDs indicating the charge status of the battery.

According to an alternative variant, the connection device configured to connect to an external charging device can comprise a further connector (not shown in the figure) connected to the control unit 20 through which it is possible to charge the battery 10 by means of a power supply cable.

Said further connector can be placed beside the connection device comprising the coil (14), as they can be used selectively, or can replace it.

This connector can, for example, be a standard female USB, mini USB or micro USB connector, in other words compatible with the majority of transformers with which electronic devices are currently equipped. In this way it is also possible to charge the battery 10 when the charging device 15 is available.

Said connector is preferably placed on the casing 2 and accessible from the outside; for this reason, it can be camouflaged as desired using decorations or studs present on the handbag.

The present innovation, as described and illustrated, is susceptible to numerous modifications and variants all included in the scope of the inventive concept; moreover, all details can be substituted by other technically equivalent elements.

1. A handbag comprising a casing (2) defining a compartment (3) with an opening (7) provided with closing means (8), illumination devices (9) placed inside said compartment (3) close to said opening (7), a battery (10) adapted to supply said illumination devices (9), a switch (11) operably connected to said closing means (8) of the compartment (3), a connection device (14) configured to connect to an external charging device, a control unit (20) configured to control at least said illumination devices (9) and said connection means (14), at least said battery (10), said connection means (14) and said control unit (20) being placed on the bottom (4) of the handbag.

2. The handbag according to claim 1, characterized in that said switch (11) comprises at least one magnet (12) and one reed contact (13), said magnet (12) being positioned on a moving portion of said closing means (8) and said reed contact (13) being positioned on the casing (2).

3. The handbag according to claim 2, characterized in that it is provided with a switch control circuit (18), interposed between the battery (10) and the illumination devices (9), capable of perceiving the open or closed state of the reed contact (13).

4. The handbag according to claim 1, characterized in that said connection device (14) comprises at least one coil (16) capable of interacting with a magnetic field emitted by a charging device (15).

5. The handbag according to claim 4, characterized in that said connection device (14) comprises a transformer circuit (17) connected to said coil (16) capable of generating an electric signal with a voltage and current value compatible with those of the battery (10).

6. The handbag according to claim 5, characterized in that said control unit (20) comprises said transformer circuit (17), said switch control circuit (18) e a charging and supply control circuit (19).

7. The handbag according to claim 1, characterized in that said battery (10), said control unit (20) and said coil (16) are produced in a single preassembled body (21).

8. The handbag according to claim 7, characterized in that said body (21) is made at least partly of a soft waterproof material capable of absorbing impacts, such as expanded polyethylene or the like.

9. The handbag according to claim 7, characterized in that said body (21) is provided with quick release connections (23) for connection to the switch (11) and to the illumination devices (9).

10. The handbag according to claim 1, characterized in that it comprises a power supply cable (26), connected to the control unit (20), provided at one end with a connector (27) for connection to a electronic device to be charged.

11. The handbag according to claim 1, characterized in that it comprises a power supply coil (35) connected to the control unit (20), adapted to generate a magnetic field to charge an electronic device.

12. The handbag according to claim 1, characterized in that said illumination devices comprise at least LED strip.

13. The handbag according to claim 1, characterized in that said connection device configured to connect to an external charging device comprises a connector connected to the control unit (20).

14. The handbag according to claim 13, characterized in that said connector is a standard female USB, mini USB or micro USB connector.

15. The handbag according to claim 13, characterized in that said connector is positioned on the outside of the casing (2) and is covered by a stud or by a decoration of the handbag.

16. The handbag according to claim 1, characterized in that it is provided with a small panel applied to the casing (2) with some LEDs indicating the charge status of the battery (10), said panel being connected to the control unit (20).

17. A kit comprising a handbag according to claim 1 and a charging device (14) provided with means (31) configured to generate a magnetic field adapted to interact with the connection means (14) of the handbag.

18. The kit according to claim 17, characterized in that said means (31) comprise at least one coil supplied by a driving circuit (32) connected to the electricity network.

19. The kit according to claim 17, characterized in that said means (31) are housed in a support (30) comprising a substantially flat thin body.

20. The kit according to claim 19, characterized in that
said means (31) comprise a plurality of coils arranged in a matrix that extends substantially for the whole of the surface of the support (30).

21. The kit according to claim 17, characterized in that said support (30) is covered with a material similar to that of the handbag.
